(19) United States
(12) Patent Application Publication
(10) Pub. No.: US 2023/0412481 A1
(43) Pub. Date: Dec. 21, 2023

(54) TERMINAL DEVICE AND WIRELESS COMMUNICATION SYSTEM THAT PERFORM CONNECTION FOR COMMUNICATION

(71) Applicant: JVCKENWOOD Corporation, Yokohama-shi (JP)

(72) Inventor: Akira KOBAYASHI, Yokohama-shi (JP)

(21) Appl. No.: 18/240,774

(22) Filed: Aug. 31, 2023

Related U.S. Application Data
(63) Continuation of application No. PCT/JP2022/004191, filed on Feb. 3, 2022.

(30) Foreign Application Priority Data
Mar. 1, 2021 (JP) 2021-031701

(51) Int. Cl. H04L 43/0852

(52) U.S. Cl. CPC H04L 43/0852

(57) ABSTRACT

A transmitter transmits a signal including type 1 identification information. A receiver receives a signal from the base station device. An extractor extracts, from the received signal, type 2 identification information, and a measurer measures a period of time after the extractor extracts the type 2 identification information. When the type 2 identification information is extracted by the extractor, the transmitter transmits a signal including the type 2 identification information. When the period of time measured by the measurer exceeds a threshold value, the transmitter transmits a signal including the type 1 identification information.

### CROSS-REFERENCE TO RELATED APPLICATION

This application is based upon and claims the benefit of priority from the prior Japanese Patent Application No. 2021-31701, filed on Mar. 1, 2021, the entire contents of which is incorporated herein by reference.

### BACKGROUND

### 1. Field

The present invention relates to communication technology and, more particularly, to terminal devices and wireless communication systems that perform connection for communication.

### 2. Description of the Related Art

A terminal device in a wireless communication system that includes a base station device and a terminal device searches a frequency band used by the base station device. That is, the terminal device periodically searches for a base station device to identify the base station device at the transmission destination (for example, Patent literature 1).
[Patent Literature 1] JP2007-228483

Since a search should be done periodically, the process for a search in the terminal device is performed periodically. The process like this increases power consumption and shortens the drive time in battery-powered terminal devices. Therefore, it is required to simplify the process in the terminal device for identifying the base station device at the transmission destination.

### SUMMARY

A terminal device according to an aspect of the embodiment includes: a transmitter that transmits a signal including type 1 identification information for indicating that a transmission destination is an unspecified base station device; a receiver that receives a signal from the base station device; an extractor that extracts, from the signal received by the receiver, type 2 identification information for identifying the base station device, the type 2 identification information being different from the type 1 identification information; and a measurer that measures a period of time after the extractor extracts the type 2 identification information, wherein, when the type 2 identification information is extracted by the extractor, the transmitter transmits a signal including the type 2 identification information, and, when the period of time measured by the measurer exceeds a threshold value, the transmitter transmits a signal including the type 1 identification information.

Another aspect of the embodiment relates to a wireless communication system. A wireless communication system includes a terminal device and a base station device. The terminal device includes: a transmitter that transmits a signal including type 1 identification information for indicating that a transmission destination is an unspecified base station device; a receiver that receives a signal from the base station device; an extractor that extracts, from the signal received by the receiver, type 2 identification information for identifying the base station device, the type 2 identification information being different from the type 1 identification information; and a measurer that measures a period of time after the extractor extracts the type 2 identification information. When the type 2 identification information is extracted by the extractor, the transmitter transmits a signal including the type 2 identification information, and, when the period of time measured by the measurer exceeds a threshold value, the transmitter transmits a signal including the type 1 identification information, the base station device includes: a receiver that receives a signal from the terminal device; an output circuit that outputs, when the signal received by the receiver includes the type 1 identification information or the type 2 identification information, the information included in the signal; and a transmitter that transmits a signal including the type 2 identification information.

Optional combinations of the aforementioned constituting elements, and implementations of the embodiment in the form of methods, apparatuses, systems, recording mediums, and computer programs may also be practiced as additional modes of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIGS. 1A-1D show a configuration of a comparative wireless communication system compared with the exemplary embodiment;

FIGS. 2A-2B show a configuration of the wireless communication system according to the exemplary embodiment;

FIG. 3 shows a configuration of the wireless communication system of FIGS. 2A-2B;

FIG. 4 is a flowchart showing a sequence of steps for transmission by the terminal device of FIG. 3;

FIGS. 5A-5B show an outline of operation of the wireless communication system according to the first application example; and

FIGS. 6A-6B show an outline of operation of the wireless communication system according to the second application example.

### DETAILED DESCRIPTION

The invention will now be described by reference to the preferred embodiments. This does not intend to limit the scope of the present invention, but to exemplify the invention.

A brief summary will be given before describing the invention in specific details. An exemplary embodiment of the present invention relates to a wireless communication system including a base station device and a terminal device. For communication between a plurality of terminal devices, a base station device is used to increase the communicable distance. Further, in order to increase the communicable distance, a plurality of base station devices are arranged, and the plurality of base station devices are connected by a network. In this process, considering the convenience in the terminal device and, for example, the convenience of not having to perform a user operation such as frequency change wherever the terminal device is, the same frequency is used for the plurality of base station devices. As a result, simultaneous access can occur.

In order to suppress the occurrence of simultaneous access, a trunking method is used, for example. In the trunking method, the terminal device always accesses the control station first and then makes a transition to an empty channel. When the trunking method is implemented, however, the number of frequencies used increases and the cost of the system also increases.

Meanwhile, the beacon method is used to suppress the occurrence of simultaneous access while using one frequency. In the beacon method, when the terminal device receives a signal by scanning in a situation where a beacon is transmitted from the base station device, the terminal device selects and uses a base station device having a high signal strength. In that process, the terminal device identifies the base station device at the transmission destination (acquires identification information for identifying the base station device) and then transmits a signal, adding the acquired identification information to the signal. Although the beacon method can be implemented by a configuration simpler than the trunking method, the terminal device must constantly receive a beacon from the base station device so that the power consumption increases and the battery drive time is shortened. Alternatively, it is possible to use the arrangement of the base station device and the directivity of the antenna in order to suppress the occurrence of simultaneous access while using one frequency. There are, however, cases where simultaneous access occurs depending on the location of the terminal device or cases where simultaneous access occurs depending climatic conditions (snowfall, rainfall, etc.) around the base station device.

In order to simplify the process for identifying the base station device at the transmission destination, the terminal device according to the exemplary embodiment does not perform a search for identifying a base station device but transmits a signal to an unspecified base station device. In response to this transmission, the base station device transmits its identification information to the terminal device. The terminal device acquires the identification information included in the signal received from the base station device. Thereafter, the terminal device performs transmission to the base station device using the acquired identification information. In this case, the terminal device may leave, in association with the movement of the user in possession of the terminal device, from the communication area of the base station device (hereinafter referred to as the “first base station device”) and move to the communication area of another base station device (hereinafter referred to as the “second base station device”). In that process, the terminal device sets a time limit and returns the transmission destination base station device to an unspecified state in order to prevent the terminal device from continuing to transmit signals to the first base station device.

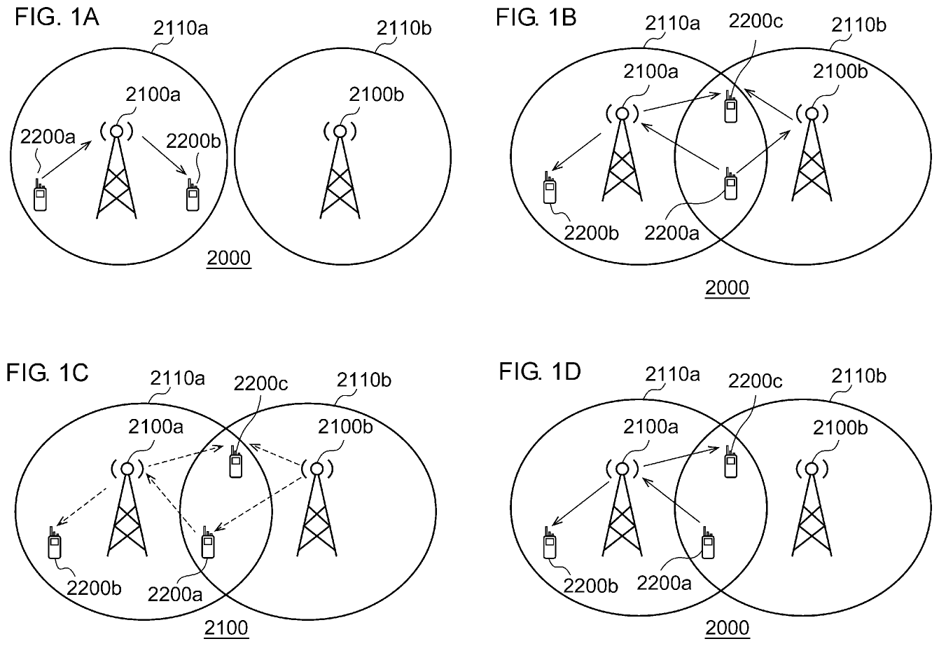

FIGS. 1A-1D show a configuration of a comparative wireless communication system 2000. The wireless communication system 2000 in FIG. 1A includes a first base station device 2100a and a second base station device 2100b, generically referred to as a base station device 2100, and a first terminal device 2200a and a second terminal device 2200b, generically referred to as a terminal device 2200. The number of base station devices 2100 and the number of terminal devices 2200 included in the wireless communication system 2000 are not limited to “2”. The first base station device 2100a and the second base station device 2100b are connected by a network (not shown).

An area in which it is possible to communicate with the first base station device 2100a is indicated as a first communication area 2110a, and an area in which it is possible to communicate with the second base station device 2100b is indicated as a second communication area 2110b. The first base station device 2100a and the second base station device 2100b are arranged so that the first communication area 2110a and the second communication area 2110b do not overlap. The first terminal device 2200a and the second terminal device 2200b are located in the first communication area 2110a, the first terminal device 2200a transmits a signal to the first base station device 2100a, and the second terminal device 2200b receives a signal from the first base station device 2100a.

The wireless communication system 2000 in FIG. 1B is similar to that of FIG. 1A, but the first base station device 2100a and the second base station device 2100b are arranged so that the first communication area 2110a and the second communication area 2110b overlap. The signal transmitted from the first terminal device 2200a is received by the first base station device 2100a and the second base station device 2100b. The first base station device 2100a and the second base station device 2100b transmit signals. Since the second terminal device 2200b receives the signal from the first base station device 2100a, the second terminal device 2200b can communicate with the first terminal device 2200a. The third terminal device 2200c receives the signal from the first base station device 2100a and the signal from the second base station device 2100b. When the wireless communication system 2000 is a digital wireless communication system, a congestion state occurs in the third terminal device 2200c, and the signals are not demodulated. When the wireless communication system 2000 is an analog wireless communication system, on the other hand, the stronger of the signals is heard in the third terminal device 2200c in an interferred state. In the following description, it is assumed that the wireless communication system 2000 is a digital wireless communication system.

FIG. 1C shows an outline of operation for preventing congestion that may occur in the third terminal device 2200c of FIG. 1B. The first base station device 2100a and the second base station device 2100b intermittently transmit signals including identification information (hereinafter referred to as “base station ID”) on the first base station device 2100a and the second base station device 2100b. The base station ID of the first base station device 2100a is different from the base station ID of the second base station device 2100b. The first terminal device 2200a receives the signal from the first base station device 2100a and the signal from the second base station device 2100b and selects the base station device 2100 that has transmitted the signal having a larger signal strength. This corresponds to selecting the base station ID of the base station device 2100 that has transmitted the signal having the larger signal strength.

FIG. 1D shows a process following FIG. 1C. Referring to FIG. 1C, the first terminal device 2200a selects the base station ID of the first base station device 2100a. The first terminal device 2200a transmits a signal including the base station ID of the first base station device 2100a. Since the received signal includes the base station ID of the first base station device 2100a, the first base station device 2100a transmits the signal. Therefore, the second terminal device 2200b and the third terminal device 2200c receive the signal from the first base station device 2100a. Meanwhile, the received signal does not include the base station ID of the second base station device 2100b, the second base station device 2100b does not transmit the signal. As a consequence of such processing, congestion does not occur in the third terminal device 2200c. However, the base station device 2100 must transmit signals intermittently, and the terminal device 2200 must always perform a reception operation. The power consumption of the terminal device 2200 increases, and the battery drive time of the terminal device 2200 is shortened.

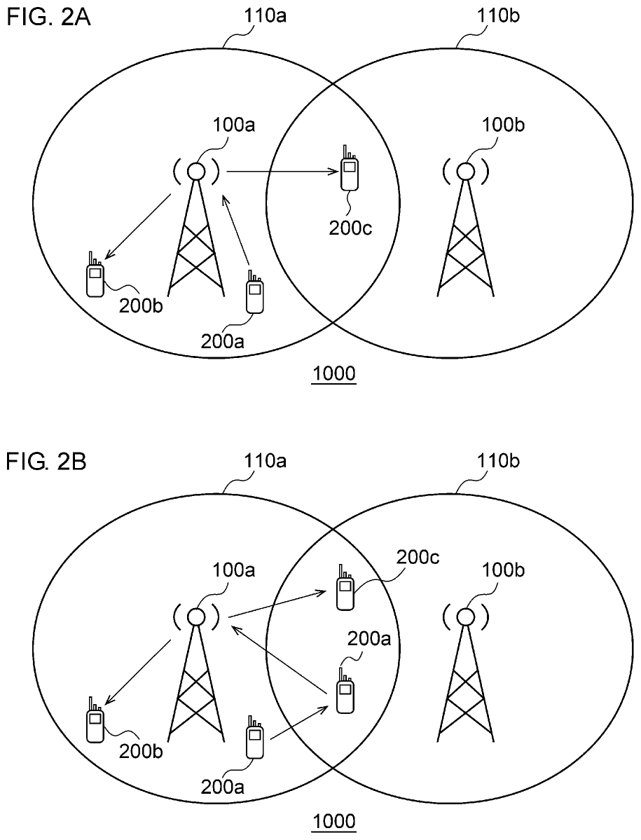

FIGS. 2A-2B show a configuration of the wireless communication system 1000. The wireless communication system 1000 in FIG. 2A includes a first base station device 100a and a second base station device 100b, generically referred to as a base station device 100, and a first terminal device 200a, a second terminal device 200b and a third terminal device 200c, generically referred to as a terminal device 200. The number of base station devices 100 included in the wireless communication system 1000 is not limited to “2”, and the number of terminal devices 200 is not limited to “3”. The first base station device 100a and the second base station device 100b are connected by a network (not shown).

An area in which it is possible to communicate with the first base station device 100a is indicated as a first communication area 110a, and an area in which it is possible to communicate with the second base station device 100b is indicated as a second communication area 110b. The first base station device 100a and the second base station device 100b are arranged so that the first communication area 110a and the second communication area 110b overlap. The first terminal device 200a is located at a position inside the first communication area 110a and outside the second communication area 110b. When the base station device 100 at the transmission destination is not determined, the first terminal device 200a transmits a signal including a base station ID (hereinafter also referred to as “type 1 identification information”) for indicating that the transmission destination is an unspecified base station device. The type 1 identification information is, for example, “Null”. This corresponds to transmitting a signal to an unspecified base station device 100. The signal also includes the addresses of the second terminal device 200b and the third terminal device 200c that are the final destinations of the signal. The signal from the first terminal device 200a is received by the first base station device 100a.

When the first base station device 100a receives the signal from the first terminal device 200a and the received signal includes type 1 identification information, the first base station device 100a transmits a signal including the base station ID of the first base station device 100a to the first terminal device 200a. The base station ID of the base station device 100 is identification information for identifying the base station device 100 and may be referred to as “type 2 identification information”. Further, the first base station device 100a transmits the signal received from the first base station device 100a to the second terminal device 200b and the third terminal device 200c. The second terminal device 200b and the third terminal device 200c receive the signal from the first base station device 100a.

When the first terminal device 200a receives the signal from the first base station device 100a, the first terminal device 200a acquires the base station ID of the first base station device 100a. Subsequently, the first terminal device 200a transmits a signal including the base station ID of the first base station device 100a. In that process, the addresses of the second terminal device 200b and the third terminal device 200c that are the final destinations of the signal are also included in the signal. This corresponds to transmitting a signal to the first base station device 100a.

When the first base station device 100a receives the signal from the first terminal device 200a and the received signal includes type 1 identification information, the first base station device 100a transmits the signal received from the first terminal device 200a is to the second terminal device 200b and the third terminal device 200c. The second terminal device 200b and the third terminal device 200c receive the signal from the first base station device 100a.

FIG. 2B shows a process following FIG. 2A. The first terminal device 200a is located at a position included in the first communication area 110a and the second communication area 110b. The first terminal device 200a transmits a signal including the base station ID of the first base station device 100a. In that process, the signal also includes the addresses of the second terminal device 200b and the third terminal device 200c that are the final destinations of the signal. When the first base station device 100a receives the signal from the first terminal device 200a and the received signal includes the base station ID of the first base station device 100a, the first base station device 100a executes the same process as described above. When the second base station device 100b receives the signal from the first terminal device 200a and the received signal includes the base station ID of the first base station device 100a, on the other hand, the base station ID of the first base station device 100a is different from the base station ID of the second base station device 100b so that the second base station device 100b does not perform the process described above. As a result, the signal from the first terminal device 200a is processed in the first base station device 100a and is not processed in the second base station device 100b.

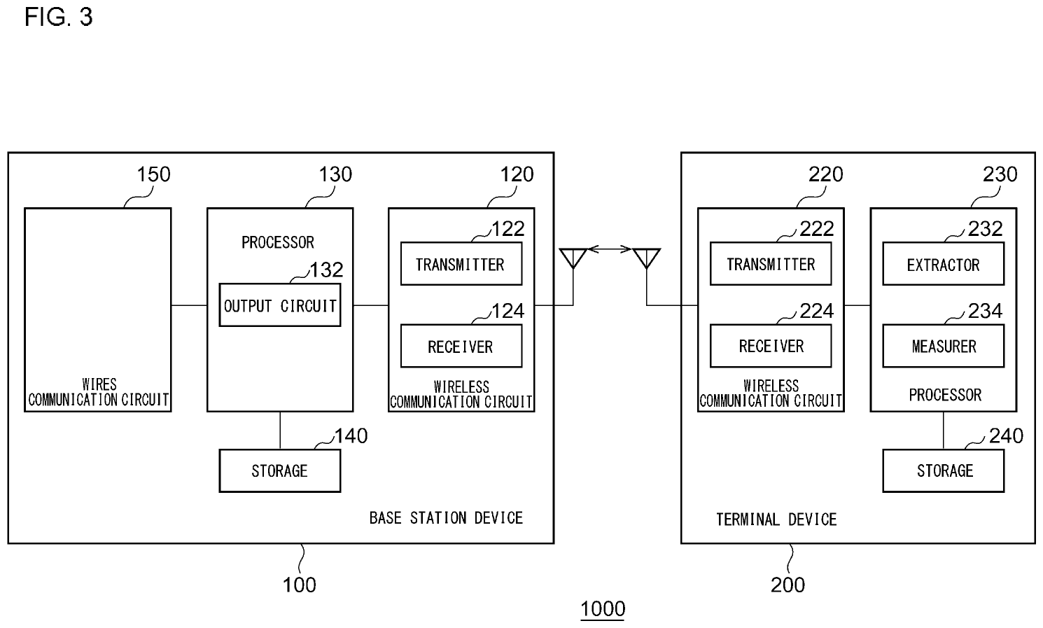

FIG. 3 shows a configuration of the wireless communication system 1000. The base station device 100 includes a wireless communication circuit 120, a processor 130, a storage 140, and a wired communication circuit 150, and the wireless communication circuit 120 includes a transmitter 122 and a receiver 124, and the processor 130 includes an output circuit 132. The terminal device 200 includes a wireless communication circuit 220, a processor 230, and a storage 240, the wireless communication circuit 220 includes a transmitter 222 and a receiver 224, and the processor 230 includes an extractor 232 and a measurer 234.

The storage 240 of the terminal device 200 stores type 1 identification information (for example, Null) to indicate that the transmission destination is an unspecified base station device 100. At the point of time of transmission of a signal, the processor 230 acquires the type 1 identification information from the storage 240 and generates a signal including the type 1 identification information. In that process, the processor 230 also includes, in the signal, the address of a further terminal device 200 that is the final destination of the signal. The transmitter 222 transmits the signal generated by the processor 230. This corresponds to transmission of a signal to an unspecified base station device 100.

The receiver 124 of the base station device 100 receives the signal from the terminal device 200. The processor 130 determines whether or not the signal received by the receiver 124 includes type 1 identification information or the base station ID of the base station device 100. The base station ID of the base station device 100 is stored in the storage 140 and corresponds to type 2 identification information described above. When the signal includes type 1 identification information, the processor 130 generates a signal including the base station ID of the base station device 100, and the transmitter 122 transmits the signal to the terminal device 200. Further, when the signal includes type 1 identification information, the output circuit 132 outputs the information included in the signal. In this case, the transmitter 122 transfers the signal to a further terminal device 200 that is the final destination. Further, the wired communication circuit 150 may transmit the signal to a further base station device 100.

The receiver 224 of the terminal device 200 receives the signal from the base station device 100. The extractor 232 extracts from the received signal the base station ID of the base station device 100 as type 2 identification information. The extractor 232 stores the extracted base station ID in the storage 240. Further, the measurer 234 measures a period of time elapsed after the extractor 232 extracts the base station ID. The processor 230 acquires the base station ID from the storage 240 at the point of time of transmission of the signal and generates a signal including the base station ID. That is, the base station ID is used in place of the type 1 identification information. In that process, the processor 230 also includes, in the signal, the address of the further terminal device 200 that is the final destination of the signal. The transmitter 222 transmits the signal generated by the processor 230.

The receiver 124 of the base station device 100 receives the signal from the terminal device 200. The processor 130 determines whether or not the signal received by the receiver 124 includes type 1 identification information or the base station ID of the base station device 100. When the signal includes the base station ID of the base station device 100, the output circuit 132 outputs the information included in the signal. In this case, the transmitter 122 transmits the signal to a further terminal device 200 that is the final destination. Alternatively, the wired communication circuit 150 may transmit the signal to the further base station device 100.

When the base station device 100 should transmit the signal to the terminal device 200, the processor 130 includes the base station ID of the base station device 100 in the signal, and the transmitter 122 transmits the signal to the terminal device 200. The receiver 224 of the terminal device 200 receives the signal from the base station device 100. The extractor 232 extracts the base station ID of the base station device 100 from the received signal. When the extractor 232 extracts the base station ID while the measurer 234 is measuring a period of time, the measurer 234 resets the period of time and then continues to measure a period of time. The processor 230 processes the received signal.

The processor 230 of the terminal device 200 deletes the base station ID stored in the storage 240 when the period of time measured by the measurer 234 exceeds a threshold value. When generating a signal in this situation, the processor 230 includes the type 1 identification information in the signal in place of the base station ID. Therefore, the terminal device 200 returns to the process of transmitting a signal to an unspecified base station device 100.

The features are implemented in hardware such as a CPU, a memory, or other LSIs, of any computer and in software such as a program loaded into a memory. The figures depict functional blocks implemented by the cooperation of these elements. Therefore, it will be understood by those skilled in the art that these functional blocks may be implemented in a variety of manners by hardware only, software only, or by a combination of hardware and software.

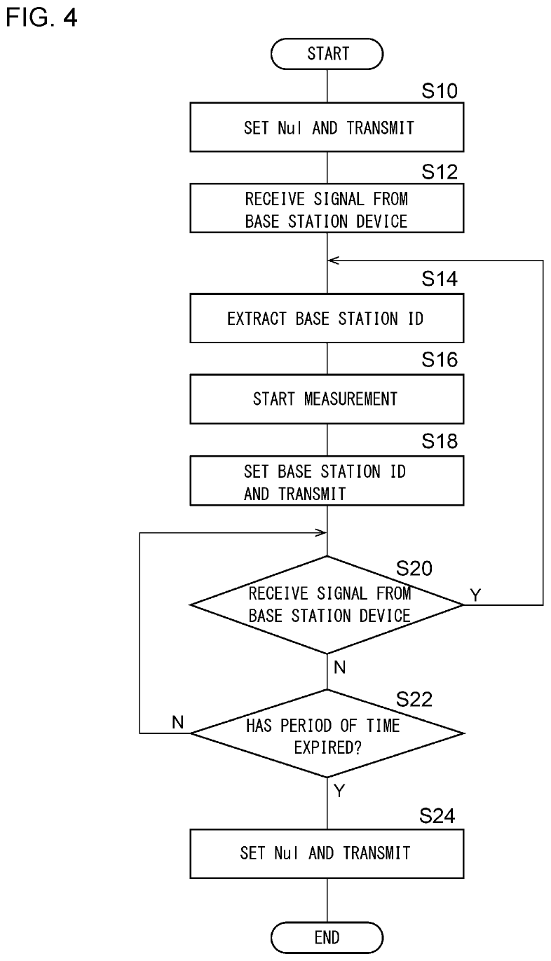

A description will be given of the operation of the wireless communication system 1000 having the above-described configuration. FIG. 4 is a flowchart showing a sequence of steps for transmission by the terminal device 200. The transmitter 222 transmits a signal in which Null is set (S10). The receiver 224 receives a signal from the base station device 100 (S12). The extractor 232 extracts the base station ID from the signal (S14). The measurer 234 starts measurement (S16). The transmitter 222 transmits a signal in which the base station ID is set (S18). When the receiver 224 receives the signal from the base station device 100 (Y in S20), the process returns to step 14. When the receiver 224 does not receive a signal from the base station device 100 (N in S20) and when the measured period of time does not expire (N in S22), the process returns to step 20. When the measured period of time expires (Y in S22), the transmitter 222 transmits a signal in which Null is set (S24).

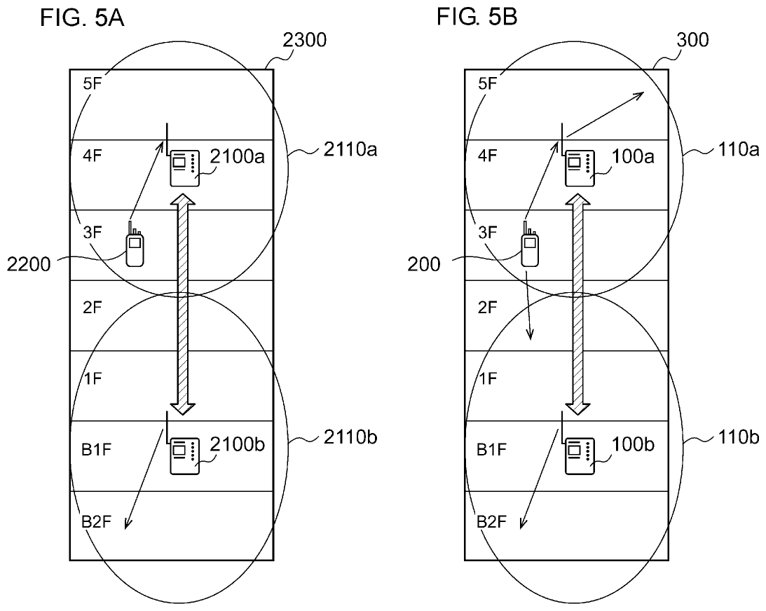

Hereinafter, an example of application of the exemplary embodiment described so far will be described. FIGS. 5A-5B show an outline of operation of the wireless communication system 1000 according to the first application example. FIG. 5A shows a comparative operation of the wireless communication system 2000. The wireless communication system 2000 is used for communication in a building 2300. The first base station device 2100a is installed on the fourth floor, the second base station device 2100b is installed on the first floor, and the first base station device 2100a and the second base station device 2100b are connected by a network (not shown). The first communication area 2110a covers the third floor to the fifth floor, and the second communication area 2110b covers the second basement floor to the second floor. Realistically, however, the first communication area 2110a and the second communication area 2110b overlap in part.

When the first base station device 2100a and the second base station device 2100b use the same frequency, congestion occurs as a result of the terminal device 2200 accessing both base station devices 2100. In order to suppress the occurrence of congestion, different frequencies are set in the first base station device 2100a and in the second base station device 2100b. When the user using the terminal device 2200 moves from the third floor to the second floor, the user must change the frequency set in the terminal device 2200.

FIG. 5B shows the operation of the wireless communication system 1000 of the exemplary embodiment. The wireless communication system 1000 is used for communication in the building 300. The first base station device 100a is installed on the fourth floor, the second base station device 100b is installed on the first floor, and the first base station device 100a and the second base station device 100b are connected by a network (not shown). The first communication area 110a covers the third floor to the fifth floor, and the second communication area 110b covers the second basement floor to the second floor. As described above, even if the first base station device 100a and the second base station device 100b use the same frequency, the terminal device 200 accesses only one of the base station devices 100 so that congestion does not occur. Further, when the user using the terminal device 200 moves from the third floor to the second floor, the user need not change the frequency set in the terminal device 200.

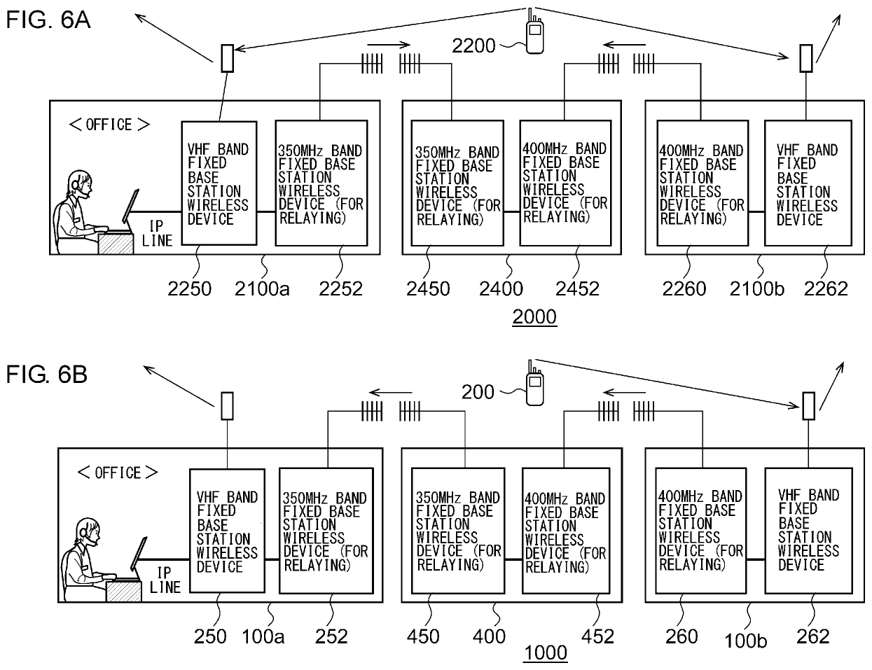

FIGS. 6A-6B show an outline of operation of the wireless communication system 1000 according to the second application example. FIG. 6A shows a comparative operation of the wireless communication system 2000. The wireless communication system 2000 connects a plurality of base station devices 2100 via a relay device 2400 to construct a communication area (not shown). The first base station device 2100a includes a VHF band fixed base station wireless device 2250, a 350 MHz band fixed base station wireless device 2252, and the relay device 2400 includes a 350 MHz band fixed base station wireless device 2450, a 400 MHz band fixed base station wireless device 2452, and the second base station device 2100b includes a 400 MHz band fixed base station wireless device 2260, a VHF band fixed base station wireless device 2262.

In the wireless communication system 2000, the base station devices 2100 are arranged so that the communication areas of the respective base station devices 2100 do not overlap. However, overlapping of the communication areas of the respective base station devices 2100 may occur due to the influence of seasons or weather conditions. Overlapping of communication areas affects interrupt communication on the control station side. The signal transmitted from the terminal device 2200 is relayed by both the first base station device 2100a and the second base station device 2100b to the communication area. Since the relay device 2400 receives signals from both the first base station device 2100a and the second base station device 2100b, a collision occurs.

In the office, the user hears the audio included in the signal received by the first base station device 2100a. In that process, the office may interrupt and transmit a signal during the transmission of the terminal device 2200. In the communication area of the first base station device 2100a, the signal from the office can be received, but the signal from the office does not reach the area of the second base station device 2100b because a collision is occurring in the relay device 2400.

FIG. 6B shows the operation of the wireless communication system 1000 of this exemplary embodiment. The wireless communication system 1000 connects a plurality of base station devices 100 via the relay device 400 to construct a communication area (not shown). The first base station device 100a includes a VHF band fixed base station wireless device 250, a 350 MHz band fixed base station wireless device 252, the relay device 400 includes a 350 MHz band fixed base station wireless device 450, a 400 MHz band fixed base station wireless device 452, and the second base station device 100b includes a 400 MHz band fixed base station wireless device 260, a VHF band fixed base station wireless device 262.

Since the signal transmitted from the terminal device 200 is received only by the second base station device 100b, the signal is relayed by the relay device 400 and transmitted from the first base station device 100a. Interrupt transmission from the office is also transmitted from the 350 MHz band fixed base station wireless device 252 of the first base station device 100a, and the relay device 400 receives the signal and performs a relay operation. The second base station device 100b receives and transmits the signal from the relay device 400.

According to this exemplary embodiment, when a signal from a base station device is received, a signal including type 2 identification information corresponding to the base station device in place of type 1 identification information is transmitted so that scanning of the signal from the base station device is made unnecessary. Further, since it is not necessary to scan the signal from the base station device, the process for identifying the base station device at the transmission destination can be simplified. In addition, since it is not necessary to scan the signal from the base station device, the battery saver can be activated. In addition, since the battery saver is activated, the power consumption can be reduced. In addition, since the power consumption is reduced, the battery drive time can be extended. Further, when the period of time since the extraction of the type 2 identification information exceeds a threshold value, a signal including type 1 identification information in place of type 2 Identification Information is transmitted, so that it is possible to switch to a further base station device. Further, when type 2 identification information is extracted while the period of time is being measured, the period of time is reset so that the period of time of use of the type 2 identification information can be extended.

The present invention has been described above based on the embodiment. The embodiment is intended to be illustrative only and it will be understood by those skilled in the art that various modifications to combinations of constituting elements and processes are possible and that such modifications are also within the scope of the present invention.

In the exemplary embodiment, the wireless communication system 1000 is described as a digital wireless communication system. However, the exemplary embodiment is not limited to this. For example, the wireless communication system 1000 may be an analog wireless communication system. The analog wireless communication system is, for example, an analog radio or specified low power radio system. In this case, type 1 identification information discussed above is a first tone signal, and type 2 identification information is a second tone signal. Also, the first tone signal and the second tone signal are different. According to this variation, it is possible to increase the flexibility of configuration.

What is claimed is:

1. A terminal device comprising:
a transmitter that transmits a signal including type 1 identification information for indicating that a transmission destination is an unspecified base station device;
a receiver that receives a signal from the base station device;
an extractor that extracts, from the signal received by the receiver, type 2 identification information for identifying the base station device, the type 2 identification information being different from the type 1 identification information; and
a measurer that measures a period of time after the extractor extracts the type 2 identification information, wherein
when the type 2 identification information is extracted by the extractor, the transmitter transmits a signal including the type 2 identification information, and
when the period of time measured by the measurer exceeds a threshold value, the transmitter transmits a signal including the type 1 identification information.

2. The terminal device according to claim 1, wherein
the measurer resets the period of time when the extractor extracts the type 2 identification information.

3. The terminal device according to claim 1, wherein
the type 1 identification information is a first tone signal,
the type 2 identification information is a second tone signal, and
the first tone signal and the second tone signal are different.

4. A wireless communication system comprising a terminal device and a base station device, wherein
the terminal device includes:
a transmitter that transmits a signal including type 1 identification information for indicating that a transmission destination is an unspecified base station device;
a receiver that receives a signal from the base station device;
an extractor that extracts, from the signal received by the receiver, type 2 identification information for identifying the base station device, the type 2 identification information being different from the type 1 identification information; and
a measurer that measures a period of time after the extractor extracts the type 2 identification information, wherein
when the type 2 identification information is extracted by the extractor, the transmitter transmits a signal including the type 2 identification information, and
when the period of time measured by the measurer exceeds a threshold value, the transmitter transmits a signal including the type 1 identification information,
the base station device includes:
a receiver that receives a signal from the terminal device;
an output circuit that outputs, when the signal received by the receiver includes the type 1 identification information or the type 2 identification information, the information included in the signal; and
a transmitter that transmits a signal including the type 2 identification information.
